(19) United States
(12) Patent Application Publication
(10) Pub. No.: US 2012/0103539 A1
(43) Pub. Date: May 3, 2012

(54) Shade Structure

(75) Inventor: JU-HUAI CHEN, Ershui Township (TW)

(73) Assignee: Chicology, Inc., Ontario, CA (US)

(21) Appl. No.: 12/917,496

(22) Filed: Nov. 2, 2010

(51) Int. Cl. E06B 9/386; E06B 9/264

(52) U.S. Cl. 160/113; 160/236; 160/181

(57) ABSTRACT

A shade structure includes a plurality of blades and a plurality of pairing units arranged in pairs such that paired ones of said pairing units are disposed at two ends of a corresponding one of the blades, respectively. The pairing units enable the shade structure to be put together or taken apart as needed, so as to enhance variability and practicability of the shade structure.

### TECHNICAL FIELD

The present invention relates to shade structures for use with blinds, and more particularly, to a shade structure with enhanced variability and practicality.

### BACKGROUND OF THE INVENTION

A conventional shade for use with a blind is usually manufactured in the form of a unitary unit and made of an appropriate material, such as cotton, a non-woven fabric, nylon, plastic, or bamboo. To start using the conventional shade for use with a blind, the shade is coupled to a winding mechanism for lowering or lifting the shade, thereby allowing the shade to block light, admit light, and look artistically pleasing.

Since the conventional shade for use with a blind is usually manufactured in the form of a unitary unit and made of a specific material, it is unlikely that the conventional shade can be assembled or disassembled as needed according to color, pattern, or size; and, as a result, the conventional shade in use is not capable of variability or practicability.

Accordingly, it is desirable to provide a shade structure configured for use with a blind and conducive to the enhancement of variability and practicability of the shade structure.

### BRIEF SUMMARY OF EMBODIMENTS OF THE INVENTION

In view of the aforesaid drawbacks of a conventional shade structure for use with a blind, the inventor of the present invention believes that the conventional shade structure has room for improvement. Thus, the inventor of the present invention endeavors to improve the conventional shade structure from the inventor's experience of the related industry. Eventually, the inventor puts forth a shade structure that features high changeability and high practicability.

It is the primary objective of the present invention to provide a shade structure that comprises blades and pairing units arranged in a manner that the pairing units enable the shade structure to be put together or taken apart as needed, so as to enhance variability and practicability of the shade structure.

In order to achieve the above and other objectives, the present invention provides a shade structure for use with a blind. The shade structure comprises: a plurality of blades; and a plurality of pairing units arranged in pairs to be disposed at two ends of a corresponding one of the blades, respectively.

In an embodiment of the present invention, the blades each have the two ends each defined with a receiving region that a corresponding one of the pairing units is disposed in the receiving region.

In an embodiment of the present invention, the pairing units may have magnetic bodies that attract to each other.

In an embodiment of the present invention, the pairing units may have mechanical fastener bodies such as Velcro® surfaces or straps that engage with each other.

In yet another embodiment of the present invention, an apparatus to provide shade is described. The apparatus comprises first and second blades. The first blade includes a first planar surface area to provide shade and a first coupling region. The second blade includes a second planar surface area to provide shade and a second coupling region. The second coupling region is configured to attach to the first coupling region when it is mated with the first coupling region. Once the first and second coupling regions are attached, the surface area of the apparatus is increased as the first and second planar surfaces are combined. The first coupling region may include a compartment to receive a magnet of a first pole, and the second coupling region may also include a compartment to receive a magnet of a second pole. In this way, the two magnets may form a paired magnets that will attach to each other. Alternatively, the first and second coupling regions comprise paired mechanical fasteners disposed directly thereon. For example, the first coupling region may comprise female mechanical fasteners and the second coupling region may comprise male mechanical fasteners.

Accordingly, a shade structure of the present invention comprises blades and pairing units arranged in a manner to enable the pairing units of the shade structure to be put together or taken apart as needed, so as to enhance variability and practicability of the shade structure.

### BRIEF DESCRIPTION OF THE DRAWINGS

A detailed description of the present invention is given below so that a person skilled in the art can fully understand the objectives, features, and advantages of the present invention by referring to the specific embodiments described hereunder in conjunction with the accompanying drawings, in which:

FIG. 1 is a perspective view of a shade structure according to an embodiment of the present invention;

FIG. 2 is an exploded view of the shade structure according to an embodiment of the present invention; and

FIG. 3 is a schematic view of an implementation of the shade structure according to an embodiment of the present invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

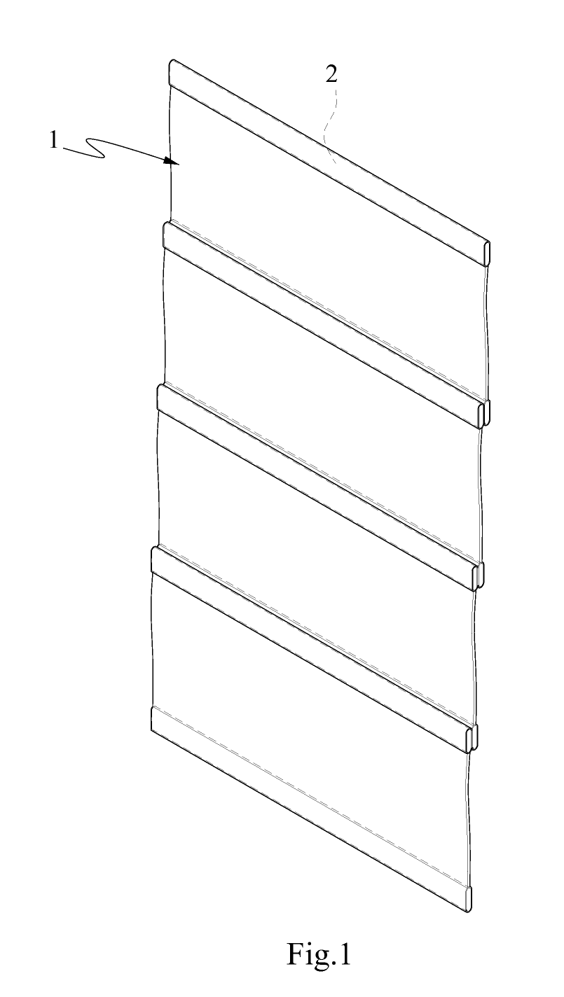

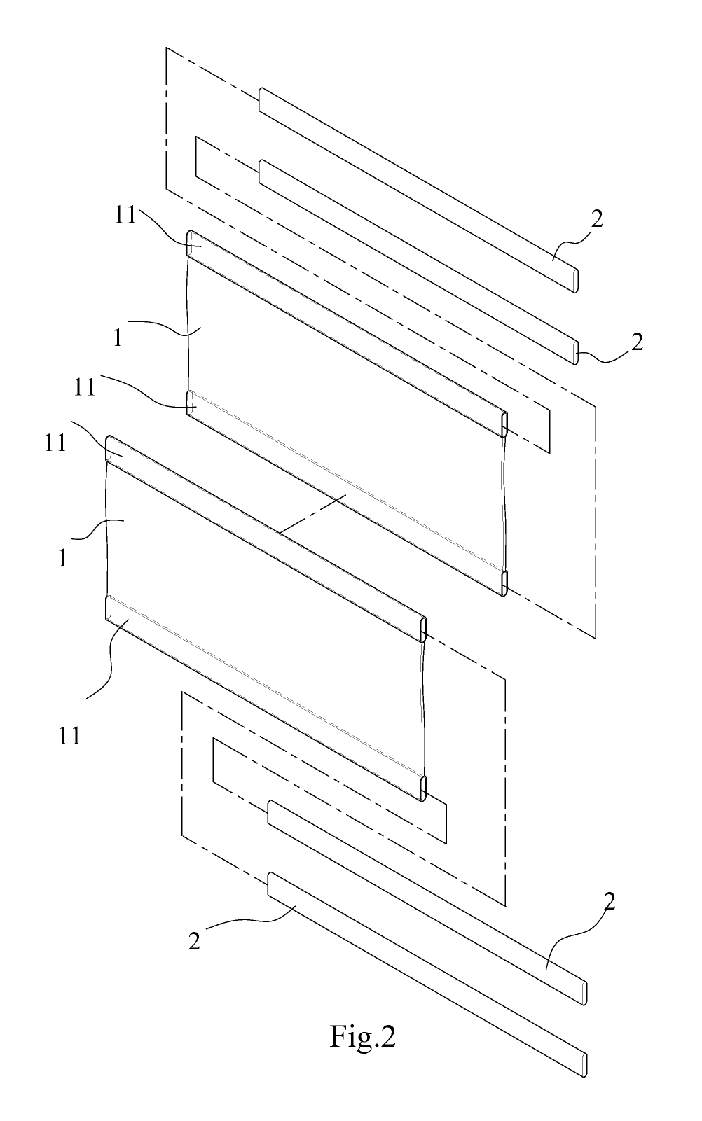

Please refer to FIGS. 1 and 2 for a perspective view and an exploded view of the present invention. As shown in the drawings, a shade structure of the present invention comprises a plurality of blades 1 and a plurality of pairing units 2.

Two ends of each of the blades 1 are each defined with a receiving region 11.

Each of the pairing units 2 may be disposed in a corresponding one of the receiving or coupling regions 11. The pairing units 2 may comprise of magnetic bodies (such as magnets) that are attracted to each other. The pairing units 2 may be a magnetic rod or bar. One or more pairing units 2 may be disposed inside of coupling regions 11. As shown in FIG. 2, coupling region 11 may comprise a compartment to receive one or more pairing units 2.

Alternatively, every two adjacent ones of the pairing units 2 are paired mechanical fasteners (such as paired Velcro® straps) for engagement with each other; and, in this aspect, the pairing units 2 which may come in the form of paired Velcro straps or paired fasteners are directly disposed at the two ends (not shown) of each of the blades 1 rather than the coupling regions 11. In the embodiment where pairing units 2 comprise mechanical fasteners that are inserted into coupling regions 11, the coupling regions 11 may include openings (not shown) on its surface to expose the mechanical fasteners. In this way, a mechanical fastener pairing unit 2 of a first blade may make physical contact with another mechanical fastener pairing unit 2 of a second blade through the openings of coupling regions 11 of each respective blades.

In another embodiment, a mechanical fastener surface may be disposed along the side of the longitudinal surface of coupling regions 11. In this embodiment, the use of pairing unit 2 may be unnecessary or may act only as a support structure. The mechanical fastener surface may be glued or sewn directly onto the outer surface of coupling regions such that it can coupled with another mechanical fastener surface of another blade as shown in FIGS. 1 and 2.

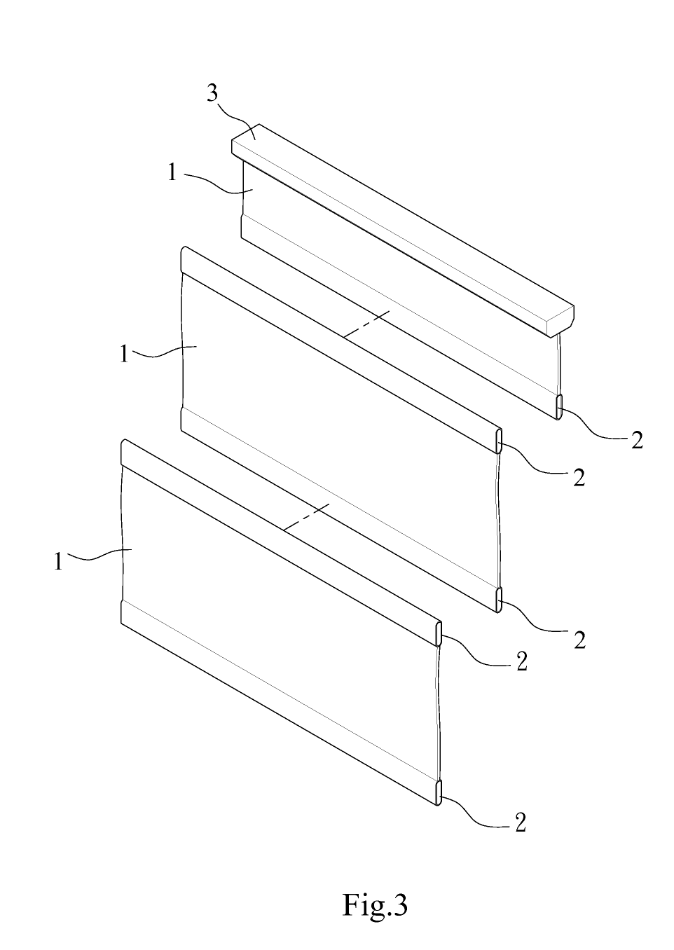

Please refer to FIG. 3 for a schematic view of use of the present invention. As shown in the drawing, to enable the shade structure of the present invention to function well, it may be desirable for the shade structure of the present invention to further comprise a winding mechanism 3 (or a blind rod or a blind frame). To start using the shade structure of the present invention, a user installs one said blade 1 on the winding mechanism 3, and then connects another said blade 1 or other said blades 1 to the one said blade 1 immediately installed on the winding mechanism 3 as needed by means of the magnetic attraction, or mechanical fastening, between adjacent ones of the pairing units 2. In this way, the shade structure of the present invention can be put together or taken apart as needed. To enhance its variability and practicability, the shade structure of the present invention is put together or taken apart as needed according to color, pattern, or size.

Hence, the present invention meets the three requirements of patentability, namely novelty, non-obviousness, and industrial applicability. Regarding novelty and non-obviousness, the present invention discloses pairing units configured to enable the shade structure of the present invention to be put together or taken apart as needed, so as to enhance variability and practicability of the shade structure. Regarding industrial applicability, products derived from the present invention meet market demands fully.

The foregoing preferred embodiments are provided to illustrate and disclose the present invention, and are not intended to be restrictive of the scope of the present invention. Hence, all equivalent modifications and replacement of the foregoing embodiments without departing from the spirit embodied in the disclosure of the present invention should fall within the scope of the present invention as set forth in the appended claims. Accordingly, the scope of the claims of the present invention should be defined by the appended claims.

1. A shade structure for use with a blind, the shade structure comprising:
a plurality of blades; and
a plurality of pairing units arranged in pairs such that paired ones of said pairing units are disposed at two ends of a corresponding one of the blades, respectively.

2. The shade structure of claim 1, wherein the blades each have the two ends each defined with a receiving region such that a corresponding one of the pairing units is disposed in the receiving region.

3. The shade structure of claim 1, wherein the pairing units are magnetic bodies attracted to each other.

4. The shade structure of claim 1, wherein the pairing units are Velcro straps for engagement with each other.

5. The shade structure of claim 1, wherein the pairing units are fasteners for engagement with each other.

6. An apparatus comprising:
a first blade having a first planar surface area to provide shade and a first coupling region;
a second blade having a second planar surface area to provide shade and a second coupling region, the second coupling region is configured to attach to the first coupling region when it is mated with the first coupling region.

7. The apparatus of claim 6, wherein the first coupling region comprises a compartment to receive a magnet of a first pole and the second coupling region comprises a compartment to receive a magnet of a second pole.

8. The apparatus of claim 6, wherein the first and second coupling regions comprise paired mechanical fasteners.
